(19) United States
(12) Patent Application Publication
(10) Pub. No.: US 2019/0353374 A1
(43) Pub. Date: Nov. 21, 2019

(54) AIR CONDITIONER SYSTEM AND CONTROL METHOD THEREOF

(71) Applicant: LG ELECTRONICS INC., Seoul (KR)

(72) Inventors: Joonkeol SONG, Seoul (KR); Sunghwan KIM, Seoul (KR)

(21) Appl. No.: 16/477,146

(22) PCT Filed: Jan. 10, 2018
(86) PCT No.: PCT/KR2018/000463

§ 371 Date: Jul. 10, 2019

(30) Foreign Application Priority Data
Jan. 10, 2017 (KR) 10-2017-0003702

(51) Int. Cl. F24F 11/38; F24F 11/61; G05B 19/042

(52) U.S. Cl. CPC F24F 11/38; F24F 11/61; G05B 2219/24015; G05B 2219/2614; G05B 19/0428

(57) ABSTRACT

The present invention relates to an air conditioner system including an integrated controller that separately determines whether sensor fault is occurred in each of the plurality of outdoor units, based on a sensing data of each of a plurality of outdoor units, and if there is an outdoor unit in which sensor fault is occurred, finally determines that sensor fault is occurred when a difference between a first sensing data of the outdoor unit in which sensor fault is occurred and a second sensing data of remaining outdoor unit is equal to or greater than a failure determination reference value, while operating the plurality of outdoor units under the same condition for a set time, and if a difference between the first sensing data and the second sensing data is less than the failure determination reference value, determines that sensor fault is not occurred, and if there is an outdoor unit determined to have sensor fault among the plurality of outdoor units, controls the outdoor unit in which sensor fault is occurred, based on the sensing data of the outdoor unit in which sensor fault is not occurred, and a control method thereof.

### TECHNICAL FIELD

The present invention relates to an air conditioner system and a control method thereof, and more particularly, to an air conditioner system for accurately determining sensor failure in a plurality of outdoor units and maintaining the operation of an outdoor unit even if a sensor fault is occurred.

### BACKGROUND ART

An air conditioner is installed to provide a comfortable indoor environment for humans by discharging cold or warm air to the room to adjust the room temperature and purify the room air so as to create a pleasant indoor environment. Generally, the air conditioner includes an indoor unit which is constituted by a heat exchanger and installed in a room, and an outdoor unit which is constituted by a compressor, a heat exchanger, and the like and supplies the refrigerant to the indoor unit.

Such an air conditioner is separated into and controlled as the indoor unit constituted by the heat exchanger, and the outdoor unit constituted by the compressor, the heat exchanger, and the like, and operated by controlling a power supplied to the compressor or the heat exchanger. In addition, at least one indoor unit may be connected to the outdoor unit, and the air conditioner is operated in a cooling mode or heating mode by supplying the refrigerant to the indoor unit according to a requested operation state.

The air conditioner is operated in the cooling mode or the heating mode depending on the flow of the refrigerant. During the cooling operation, when the high-temperature and high-pressure liquid refrigerant is supplied from the compressor of the outdoor unit to the indoor unit through the heat exchanger of the outdoor unit, the refrigerant is expanded and vaporized in the heat exchanger of the indoor unit, and the temperature of the ambient air is lowered so that cool air is discharged into the room as an indoor fan is rotated. During the heating operation, when the high-temperature and high-pressure gas refrigerant is supplied from the compressor of the outdoor unit to the indoor unit, the air warmed by the energy that is released as the gas refrigerant of high temperature and high pressure is liquefied in the heat exchanger of the indoor unit is discharged to the room according to the operation of the indoor fan.

Such an air conditioner includes a plurality of temperature sensors, and sucks air and discharges cold or warm air according to a set operation mode. At this time, the air conditioner measures indoor temperature by measuring the suction temperature, and operates the indoor temperature to reach a desired temperature.

The air conditioner is operated in any one cycle of the cooling operation or the heating operation to discharge cold or warm temperature air to the room.

The air conditioner system including a plurality of indoor units and a plurality of outdoor units includes an integrated controller for controlling the plurality of indoor units and the plurality of outdoor units. The plurality of indoor units and the plurality of outdoor units are controlled according to a control signal provided by the integrated controller.

However, when the sensor of a certain outdoor unit fails, a corresponding outdoor unit can not perform a normal operation. Therefore, it is necessary to determine more precisely whether the sensor of the outdoor unit in the system is broken.

In addition, in a conventional air conditioner system, when the sensor of the outdoor unit fails, the operation of the outdoor unit should be stopped, as the outdoor unit can not operate normally. However, even when the sensor of the outdoor unit is broken, it is necessary to normally operate the outdoor unit.

### DISCLOSURE

### Technical Problem

An object of the present invention is to provide an air conditioner system for more accurately determining a sensor failure of an outdoor unit in an air conditioner system including a plurality of outdoor units, a plurality of indoor units, and an integrated controller, and a control method thereof.

It is another object of the present invention to provide an air conditioner system for maintaining the operation of an outdoor unit in which a sensor has failed, and a control method thereof.

The problems of the present invention are not limited to the above-mentioned problems, and other problems not mentioned can be clearly understood by those skilled in the art from the following description.

### Technical Solution

In an aspect, there is provided an air conditioner system including: a plurality of indoor units; a plurality of outdoor units; and an integrated controller for separately controlling the plurality of indoor units and the plurality of outdoor units, wherein, when it is determined that a sensor fault is occurred in a first outdoor unit among the plurality of outdoor units, the integrated controller controls the first outdoor unit, based on sensing data of remaining outdoor units in which sensor fault is not occurred excluding the first outdoor unit.

When the first sensing data received from the first outdoor unit is abnormal sensing data, or when the first sensing data received from the first outdoor unit deviates from a set sensing range, the integrated controller determines that the first outdoor unit is an outdoor unit in which sensor fault is occurred.

The integrated controller determines that sensor fault is occurred in the first outdoor unit when sensing data is not transmitted from the first outdoor unit for a preset time, among the plurality of outdoor units.

In another aspect, there is provided a method of controlling an air conditioner system comprising a plurality of indoor units, a plurality of outdoor units, and an integrated controller for separately controlling the plurality of indoor units and the plurality of outdoor units, the method including: a reception step of receiving sensing data from the plurality of outdoor units by the integrated controller; a determination step of determining that sensor fault is occurred in the first outdoor unit, among the plurality of outdoor units corresponding to the sensing data, by the integrated controller; and a control step of controlling the first outdoor unit, based on sensing data of remaining outdoor units in which sensor fault is not occurred excluding the first outdoor unit.

The determination step further includes the steps of: operating the plurality of outdoor units for a set time under the same condition; determining whether a difference between a first sensing data of the first outdoor unit and a second sensing data of the remaining outdoor unit is greater than or equal to a failure determination reference value; and finally determining that a sensing error has occurred in the first outdoor unit if the difference between the first sensing data and the second sensing data is greater than or equal to the failure determination reference value.

The details of other embodiments are included in the detailed description and drawings.

### Advantageous Effects

According to an embodiment of the present invention, there is one or more of the following effects.

Sensor fault is determined based on the sensor data of each of the plurality of outdoor units, and sensor fault is determined by comparing the respective sensor data while operating the plurality of outdoor units under the same condition, thereby determining a sensor failure more accurately.

The outdoor unit in which sensor fault is occurred is controlled based on the sensing data of the outdoor unit in which sensor fault is not occurred, so that the outdoor unit in which sensor fault is occurred can be continuously operated.

The effects of the present invention are not limited to the effects mentioned above, and other effects not mentioned can be clearly understood by those skilled in the art from the description of the claims.

### DESCRIPTION OF DRAWINGS

FIG. 1 is a view for explaining an outdoor unit of an air conditioner system.

FIG. 2 is a view for explaining a configuration of a conventional air conditioner system.

FIG. 3 is a view for explaining a configuration of an air conditioner system according to the present invention.

FIG. 4 is a block diagram for explaining an integrated controller according to the present invention.

FIG. 5A and FIG. 5B are block diagrams for explaining a structure of an indoor unit and an outdoor unit.

FIG. 6 is a view for explaining a method of controlling an indoor unit and an outdoor unit by an integrated controller in a conventional air conditioner system.

FIG. 7 is a view for explaining a method of controlling an indoor unit and an outdoor unit by an integrated controller in an air conditioner system of the present invention.

FIG. 8 and FIG. 9 are flowcharts for explaining a method of controlling an air conditioner system according to the present invention.

FIG. 10 is a view for explaining a state where an integrated controller of the present invention compares sensor data while operating a plurality of outdoor units under the same condition.

### MODE FOR INVENTION

Hereinafter, preferred embodiments of the present invention will be described with reference to the accompanying drawings. For the sake of brief description with reference to the drawings, the same or equivalent components may be denoted by the same reference numbers, and description thereof will not be repeated. In general, suffixes such as “module” and “unit” may be used to refer to elements or components. Use of such suffixes herein is merely intended to facilitate description of the specification, and the suffixes do not have any special meaning or function. In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings. It will be understood that although the terms first, second, etc. may be used herein to describe various elements, these elements should not be limited by these terms. These terms are only used to distinguish one element from another. It will be understood that when an element is referred to as being “connected with” another element, there may be intervening elements present. In contrast, it will be understood that when an element is referred to as being “directly connected with” another element, there are no intervening elements present. A singular representation may include a plural representation unless context clearly indicates otherwise. Terms such as “includes” or “has” used herein should be considered as indicating the presence of several components, functions or steps, disclosed in the specification, and it is also understood that more or fewer components, functions, or steps may likewise be utilized.

The air conditioner of the present invention can be applied to any of a stand type air conditioner, a wall-mounted type air conditioner, a ceiling type air conditioner, and the like. For the sake of convenience, a system air conditioner in which a unit including a plurality of outdoor units and indoor units is connected to an apparatus for integrated control will be described as an example.

The air conditioner according to the present invention may include a plurality of units such as an indoor unit for discharging cold or warm air to a room, an outdoor unit connected to the indoor unit. Particularly, a plurality of indoor units are connected to the outdoor unit, so that the outdoor units can supply the refrigerant to the plurality of connected indoor units.

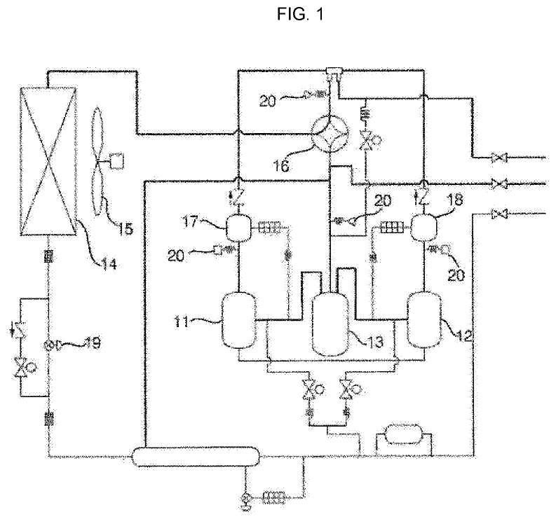

FIG. 1 is a view for explaining an outdoor unit of an air conditioner system.

The outdoor unit may include a compressor 11, 12 for receiving and compressing the refrigerant, an outdoor heat exchanger 14 for exchanging heat between the refrigerant and outdoor air, an accumulator 13 for extracting the gas refrigerant from the supplied refrigerant and supplying it to the compressor, and a four-way valve 16 for selecting the flow path of the refrigerant according to the heating operation.

The outdoor unit may include a sensor 20 including a high pressure sensor for measuring the pressure of the refrigerant discharged from the compressor 11, 12 and a low pressure sensor for measuring the pressure of the refrigerant supplied to the compressor, and an electronic expansion valve 19 for expanding the compressed refrigerant.

The outdoor unit may include various sensors 20 for measuring temperature or pressure. A refrigerant pipe inside the outdoor unit may be provided with various sensors 20 for measuring temperature or pressure. The plurality of outdoor units included in the air conditioner system of the present invention may include sensors 20 of the same type in the same position. For example, each of the plurality of outdoor units included in the air conditioner system of the present invention includes a temperature sensor disposed in the refrigerant pipe at a certain distance from an expansion valve, and a pressure sensor disposed in the refrigerant pipe through which the refrigerant is discharged from the compressor.

The sensor 20 provided in the outdoor unit may generate sensing data corresponding to the measured temperature or pressure and provide it to a main controller or an integrated controller of the outdoor unit. The main controller of the outdoor unit may transmit the received sensing data to the integrated controller. The integrated controller may receive the sensing data of the sensor 20 provided in the outdoor unit, and determine whether a fault is occurred in the sensor 20 of the outdoor unit, based on the sensing data.

The outdoor unit further includes a valve and an oil recovery device, but the description of other components will be omitted in the following. Further, it should be noted that the type and the number of the compressor included in the outdoor unit are not limited to the drawings.

In the compressor 11, 12, a refrigerant suction unit is connected to an accumulator 13, and a pipe is connected to a discharge unit, and an oil separator may be installed to recover oil from the refrigerant discharged from the compressor. The outdoor heat exchanger 14 is connected to the four-way valve 16 so that the refrigerant is condensed or evaporated by heat exchange with the outside air. At this time, in order to facilitate the heat exchange of the outdoor heat exchanger 14, the outdoor fan 15 introduces air into the outdoor heat exchanger 14.

The outdoor heat exchanger 14 is used as a condenser during a cooling operation, or an all-room cooling operation or a cooling major operation with heating minor operation in a simultaneous cooling and heating type system, and the outdoor heat exchanger 14 is used as an evaporator during an all-room heating operation or a heating major operation with cooling minor operation.

An outdoor electronic expansion valve 19 and a supercooling device are installed in a liquid pipe connecting the outdoor heat exchanger 14 and the indoor unit or a distributor.

The electronic expansion valve 19 expands the condensed refrigerant during the heating operation, the all-room heating operation or the heating major operation with cooling minor operation, and the supercooling device cools the refrigerant transferred to the indoor unit or the distributor during the cooling operation, the all-room cooling operation or the cooling major operation with heating minor operation.

The indoor unit may include the indoor heat exchanger, the indoor fan, the expansion valve for expanding the refrigerant supplied from the outdoor unit, and a plurality of sensors.

Hereinafter, a conventional air conditioner system and an air conditioner system according to the present invention will be described with reference to the drawings.

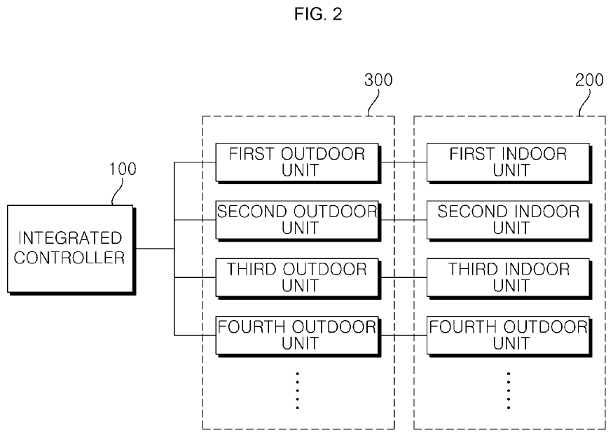

FIG. 2 is a view for explaining a configuration of a conventional air conditioner system.

The conventional air conditioner system may include an indoor unit 200, an outdoor unit 300, and an integrated controller 100.

There may be one or more indoor units 200 included in the air conditioner system. The outdoor unit 300 included in the air conditioner may be one or more.

One or more indoor units 200 may be connected to one outdoor unit 300. The number of the indoor units 200 connected to the outdoor unit 300 may vary depending on the capacities of the outdoor unit 300 and the indoor unit 200.

The integrated controller 100 may perform communication with the outdoor unit 300. The integrated controller 100 may acquire information on the outdoor unit 300 and information on one or more indoor units 200 connected to the outdoor unit 300 from the outdoor unit 300.

In the conventional air conditioner system, one or more indoor units 200 are connected to one outdoor unit 300. The integrated controller 100 should receive the information of the indoor unit 200 through the outdoor unit 300. Therefore, when the outdoor unit 300 fails, the integrated controller 100 can not acquire information on the outdoor unit 300 and the information on the indoor unit 200. Since the integrated controller 100 can not acquire information on the indoor unit 200 when the outdoor unit 300 fails, stability of the system can be reduced as a whole.

The conventional air conditioner system has a problem in that when the outdoor unit 300 fails, there occurs a problem in controlling the indoor unit 200 connected to the failed outdoor unit 300.

The integrated controller 100 of the conventional air conditioner system may control the outdoor unit 300 and the indoor unit 200. Since the indoor unit 200 of the conventional air conditioner system is connected to the integrated controller 100 through the outdoor unit 300, a control signal for the indoor unit 200 transmitted by the integrated controller 100 is transmitted to the indoor unit 200 through the outdoor unit 300. In this case, if the outdoor unit 300 fails, the integrated controller 100 can not control the indoor unit 200.

As described above, in the conventional air conditioner system, the indoor unit 200 is connected to the outdoor unit 300, and the integrated controller 100 for controlling the indoor unit 200 and the outdoor unit 300 is connected to the outdoor unit 300, so that the indoor unit 200 and the integrated controller 100 are not directly connected to each other. Therefore, when the outdoor unit 300 fails, there may occur a problem in the control of the integrated controller 100 for the indoor unit 200 as well.

The air conditioner system according to the present invention may control the indoor unit 200 even if the outdoor unit 300 fails, as the integrated controller 100 is directly connected to the indoor unit 200 and the outdoor unit 300. Hereinafter, the structure of the air conditioner system according to the present invention will be described.

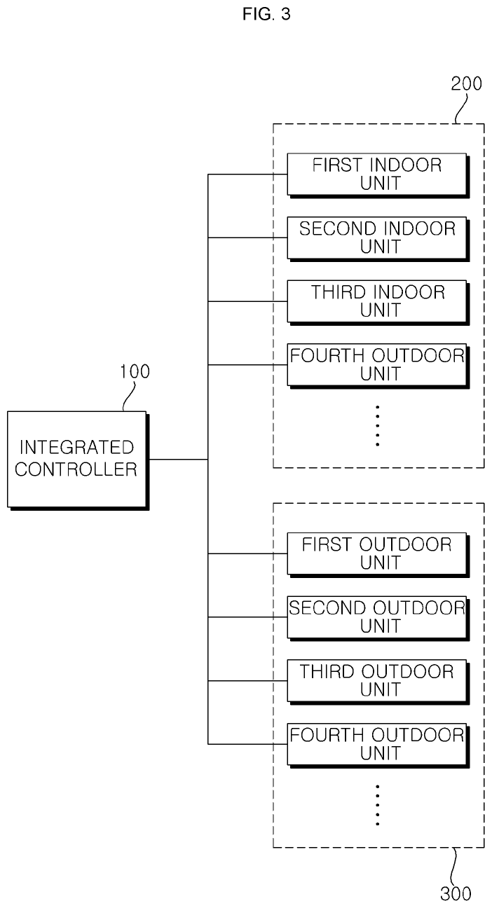

FIG. 3 is a view for explaining a configuration of an air conditioner system according to the present invention.

The air conditioner system according to the present invention may include the indoor unit 200, the outdoor unit 300, and the integrated controller 100.

The indoor unit 200 included in the air conditioner system according to the present invention may be one or more. The outdoor unit 300 included in the air conditioner may be one or more.

The integrated controller 100 of the present invention may perform communication with the indoor unit 200 and the outdoor unit 300 separately. To this end, the integrated controller 100 of the present invention may be connected to the indoor unit 200 and the outdoor unit 300 separately. The integrated controller 100 may acquire necessary information from at least one of one or more indoor units 200 and one or more outdoor units 300.

The integrated controller 100 of the present invention may include a communication module (not shown) for performing communication with other device. Other device may include a communication device provided in the outdoor unit 300 and a communication device provided in the indoor unit 200.

The integrated controller 100 of the present invention may receive information transmitted from the outdoor unit 300 or the indoor unit 200 through a communication module. Unlike the conventional air conditioner, the integrated controller 100 of the air conditioner according to the present invention is directly connected to the indoor unit 200, so that it can receive information of the indoor unit 200, not through the outdoor unit 300. Accordingly, the integrated controller 100 may stably acquire information on the indoor unit 200 even when the outdoor unit 300 fails.

The integrated controller 100 of the present invention may communicate with the indoor unit 200 and the outdoor unit 300 separately to receive information on at least one of the indoor unit 200 and the outdoor unit 300. For example, the integrated controller 100 may receive respective state information from at least one of one or more outdoor units 300 and indoor units 200. The state information may be information indicating an operation state, an operation state, an error state, a setting state, various sensing values, and the like of the outdoor unit 300 or the indoor unit 200. The integrated controller 100 may determine the setting of the outdoor unit 300 or the indoor unit 200 or determine a specific performed operation, based on the state information.

The integrated controller 100 of the present invention is directly connected to each of the outdoor unit 300 and the indoor unit 200 separately, so that the indoor unit 200 can be stably controlled even if the outdoor unit 300 fails.

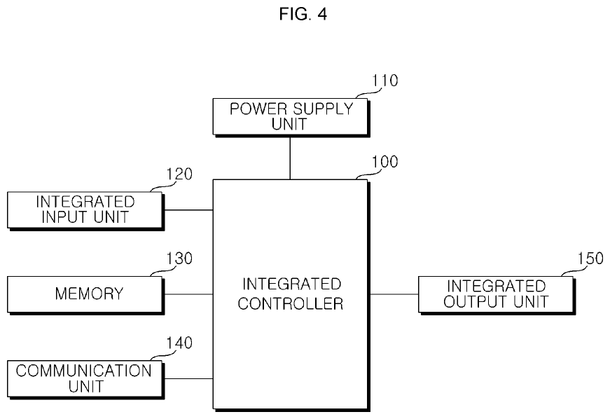

FIG. 4 is a block diagram for explaining an integrated controller according to the present invention.

The integrated controller 100 may be electrically connected to an integrated input unit 120, a memory 130, a communication unit 140, the integrated output unit 150, and the power supply unit 110.

The integrated input unit 120 may receive various inputs from a user. For example, the integrated input unit 120 may receive a user input for the indoor unit 200 or the outdoor unit 300 connected to the integrated controller 100. The integrated input unit 120 may transmit the received user input to the integrated controller 100.

The memory 130 may store various information on the integrated controller 100, the outdoor unit 300, and the indoor unit 200. For example, the memory 130 may store information on the setting and specification of each component constituting the air conditioner system. The integrated controller 100 may use the information stored in the memory 130.

The communication unit 140 may perform communication with other device. The communication unit 140 may communicate with the indoor unit 200 or the outdoor unit 300 of the air conditioner system. The communication unit 140 may perform wired or wireless communication.

The communication unit 140 may provide information received from other device to the integrated controller 100. For example, the communication unit 140 may transmit the state information transmitted from the outdoor unit 300 or the indoor unit 200 of the air conditioner system to the integrated controller 100.

The communication unit 140 may transmit signal and data provided by the integrated controller 100 to other device. For example, the communication unit 140 may transmit a signal for controlling the indoor unit 200 or the outdoor unit 300 provided by the integrated controller 100 to the indoor unit 200 or the outdoor unit 300.

The integrated output unit 150 is a device that can output various information related to the air conditioner system. The integrated output unit 150 may include at least one of a display device and an audio output device. The integrated controller 100 may output the image or sound corresponding to the acquired information through the integrated output unit 150.

The power supply unit 110 may be a device that supplies power for the integrated controller 100. The integrated controller 100 may be operated by the power supplied from the power supply unit 110.

The integrated controller 100 may be connected to the indoor unit 200 and the outdoor unit 300 through the communication unit 140 to control the indoor unit 200 or the outdoor unit 300. The integrated controller 100 may perform a direct control or an indirect control, with respect to the indoor unit 200 or the outdoor unit 300.

The direct control is a method that the integrated controller 100 controls the indoor unit 200 or the outdoor unit 300 that does not have a main controller. The integrated controller 100 may directly provide a control signal for a driving device provided in each unit, when controlling the indoor unit 200 or the outdoor unit 300 that does not have the main controller. Accordingly, the indoor unit 200 or the outdoor unit 300 can be operated only by the control signal provided by the integrated controller 100, even if the main controller does not exist. In this case, the signal provided by the integrated controller 100 may be named a direct control signal. That is, the direct control is a method that the integrated controller 100 directly controls the indoor unit 200 or the outdoor unit 300.

When the integrated controller 100 performs the direct control, with respect to the outdoor unit 300 or the indoor unit 200, the main controller does not exist in the outdoor unit 300 and the indoor unit 200, so that the cost can be reduced. In addition, since the entire air conditioner system is operated by a single integrated controller 100, the management of the system can be efficiently performed.

The indirect control is a method that the integrated controller 100 controls the indoor unit 200 or the outdoor unit 300 that does not have the main controller. When controlling the outdoor unit 300 or the indoor unit 200 that does not have the main controller, the integrated controller 100 does not directly provide the control signals for the driving device provided in each unit, and may provide a signal that enables each main controller to control the driving device. Since the main controller exists in the indoor unit 200 or the outdoor unit 300, the integrated controller 100 can provide a control signal corresponding to a specific operation to each main controller. The main controller of the indoor unit 200 or the outdoor unit 300 may control the driving device of the indoor unit 200 or the outdoor unit 300, based on the control signal provided by the integrated controller 100. In this case, the signal provided to the main controller by the integrated controller 100 may be named an indirect control signal. That is, the indirect control is a method that the integrated controller 100 indirectly controls the indoor unit 200 or the outdoor unit 300 by transmitting a certain command to the main controller of the indoor unit 200 or the outdoor unit 300.

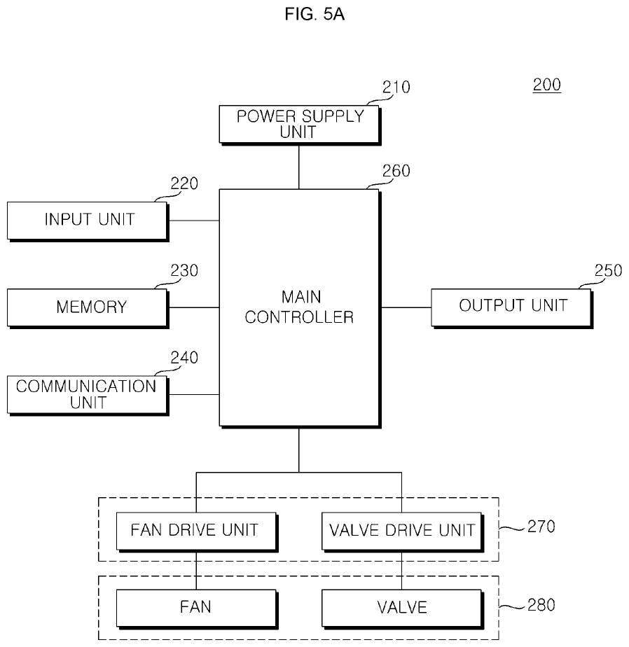

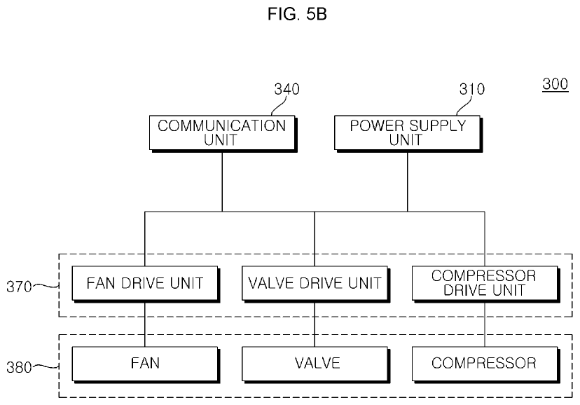

FIG. 5A and FIG. 5B are block diagrams for explaining a structure of an indoor unit and an outdoor unit.

The indoor unit 200 and the outdoor unit included in the air conditioner system according to the present invention may include the main controller 260 or may not include the main controller 260.

FIG. 5A shows the indoor unit 200 including the main controller 260.

Referring to FIG. 5A, the indoor unit 200 according to the present invention includes a main controller 260, an input unit 220, a memory 230, a communication unit 240, an output unit 250, a drive unit 270, a driving device 280, and a power supply unit 210.

Since the main controller 260, the input unit 220, the memory 230, the communication unit 240, the output unit 250, and the power supply unit 210 perform the same function in the indoor unit 200 or the outdoor unit, these will be described in common.

The input unit 220 may receive various inputs from user. For example, the input unit 220 may receive user input for the indoor unit 200. The input unit 220 may transmit the received user input to the main controller 260. The main controller 260 may control the driving device 280 in response to the user input received from the input unit 220.

The memory 230 may store information on various modules included in the indoor unit 200. For example, the memory 230 may store information on the setting and the specification of the indoor unit 200. The main controller 260 may use the information stored in the memory 230.

The communication unit 240 may perform communication with other device. The communication unit 240 may perform communication with the integrated controller 100. The communication unit 240 may perform wired or wireless communication.

The communication unit 240 may provide the main controller 260 with information received from other device. For example, the communication unit 240 may transmit a control signal transmitted from the integrated controller 100 to the main controller 260.

The communication unit 240 may transmit the signal and data provided by the main controller 260 to other device. For example, the communication unit 240 may transmit state information on the indoor unit 200 provided by the main controller 260 to the integrated controller 100.

For example, the communication unit 240 included in the outdoor unit may transmit the state information of the outdoor unit to the integrated controller 100. The communication unit 240 may receive the direct control signal or the indirect control signal transmitted by the integrated controller 100.

For example, the communication unit 240 included in the indoor unit 200 may transmit the state information of the indoor unit 200 to the integrated controller 100. The communication unit 240 may receive the direct control signal or the indirect control signal transmitted by the integrated controller 100.

The output unit 250 is a device that can output various information related to the indoor unit 200. The output unit 250 may include at least one of a display device and an audio output device. The main controller 260 may output the image or sound corresponding to acquired information through the output unit 250.

The power supply unit 210 may be a device for supplying power to various units of the main controller 260 and the indoor unit 200. Various units of the main controller 260 and the indoor unit 200 may be operated by the power supplied from the power supply unit 210.

The main controller 260 may be electrically connected to the input unit 220, the memory 230, the communication unit 240, the output unit 250, and the drive unit 270 to control each module. For example, the main controller 260 of the indoor unit 200 may implement the cooling or heating operation of the indoor unit 200 by controlling the drive unit 270.

The main controller 260 may control various units provided in the indoor unit 200. The main controller 260 of the indoor unit 200 may control various units of the indoor unit 200, based on the control signal transmitted by the integrated controller 100. The main controller 260 may transmit a signal for controlling the driving device 280 to the drive unit 270, and the drive unit 270 may drive the driving device 280 according to a signal transmitted by the main controller 260. Accordingly, the operation of the indoor unit 200 may be implemented.

The main controller 260 may control the driving device 280, based on the indirect control signal transmitted by the integrated controller 100. The indirect control signal is a signal for indirectly controlling the driving device 280 through the main controller 260 while the integrated controller 100 does not directly control the driving device 280 of the indoor unit 200.

The driving device 280 included in the indoor unit 200 is an apparatus that is provided in the indoor unit 200 and performs a specific operation under the control of the drive unit 270. For example, the driving device 280 included in the indoor unit 200 may include a fan and a valve. The valve may be an expansion valve.

The drive unit 270 included in the indoor unit 200 may drive the driving device 280 included in the indoor unit 200, based on the control signal received from the main controller 260 or the integrated controller 100. For example, the drive unit 270 may include a fan drive unit 270 for driving the fan, and a valve drive unit 270 for driving the valve.

The embodiment of FIG. 5B shows an outdoor unit 300 that does not include a main controller.

Referring to FIG. 5B, an outdoor unit 300 according to the present invention may include a communication unit 340, a drive unit 370, a driving device 380, and a power supply unit 310.

The indoor unit and the outdoor unit 300 included in the air conditioner system according to the present invention may not include the main controller. The integrated controller 100 of the present invention may perform direct control by directly providing control signal separately to the outdoor unit 300 and the indoor unit, even if the indoor unit and the outdoor unit 300 do not have the main controller.

The driving device 380 included in the outdoor unit 300 is an apparatus that is provided in the outdoor unit 300 and performs a specific operation under the control of the drive unit 370. For example, the driving device 380 included in the outdoor unit 300 may include a fan, a valve, and a compressor. The valve may include an expansion valve and a four-way valve.

The drive unit 370 included in the outdoor unit 300 may drive the driving device 380 included in the outdoor unit 300, based on the direct control signal transmitted from the integrated controller 100. For example, the drive unit 370 included in the outdoor unit 300 may include a fan drive unit for driving the fan, a valve drive unit for driving the valve, and a compressor drive unit for driving the compressor.

The communication unit 340 may perform communication with the integrated controller 100. The communication unit 340 may transmit the direct control signal transmitted from the integrated controller 100 to the drive unit 370. For example, the communication unit 340 may transmit a direct control signal for fan to the fan drive unit.

The communication unit 340 may transmit information on the operation of the drive unit 370 to the integrated controller 100. For example, the communication unit 340 may transmit to the integrated controller 100 information on the speed at which the fan drive unit rotates the fan and the time.

The power supply unit 310 may supply power to the drive unit 370 and the driving device 380. The drive unit 370 and the driving device 380 may be operated by the power supplied from the power supply unit 310.

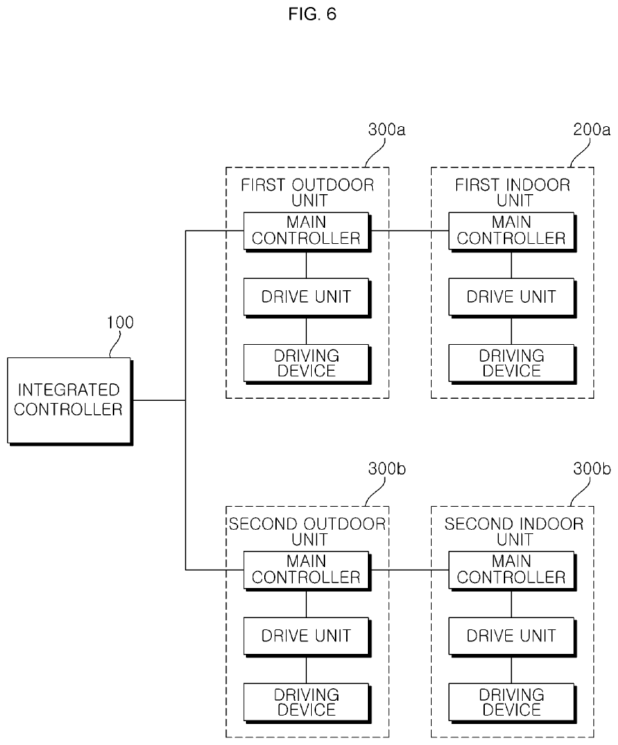

FIG. 6 is a view for explaining a method of controlling an indoor unit and an outdoor unit by an integrated controller in a conventional air conditioner system.

Each of the indoor unit 200 and the outdoor unit 300 of the conventional air conditioner system includes a main controller.

For example, in order to control a first outdoor unit 300a and a first indoor unit 200a, the integrated controller 100 may transmit a control signal for the first outdoor unit 300a and a control signal for the first indoor unit 200a to the first outdoor unit 300a. The main controller of the first outdoor unit 300a may control various units provided in the first outdoor unit 300a, based on the control signal for the first outdoor unit 300a transmitted by the integrated controller 100. The main controller of the first outdoor unit 300a may transmit a control signal for the first indoor unit 200a transmitted by the integrated controller 100 to the first indoor unit 200a. The main controller of the first indoor unit 200a may control various units provided in the first indoor unit 200a, based on the control signal for the first indoor unit 200a transmitted from the main controller of the first outdoor unit 300a.

As described above, the fact that the main controller of each of the indoor unit 200 and the outdoor unit 300 controls the indoor unit 200 or the outdoor unit 300, based on the control signal provided by the integrated controller 100 may be named an indirect control. In this case, it may be expressed that the integrated controller 100 performs indirect control for the indoor unit 200 and the outdoor unit 300. When the integrated controller 100 performs the indirect control for the outdoor unit 300 and the indoor unit 200, the control signal transmitted to the outdoor unit 300 and the indoor unit 200 may be named an indirect control signal.

The indirect control signal is a control signal that the integrated controller 100 provides to the main controller of the indoor unit 200 or the outdoor unit 300. The indirect control signal is a signal that enables the main controller of the indoor unit 200 or the outdoor unit 300 to control the indoor unit 200 or the outdoor unit 300. The main controller of the indoor unit 200 or the outdoor unit 300 may control each of the outdoor unit 300 or the indoor unit 200, based on the indirect control signal provided by the integrated controller 100.

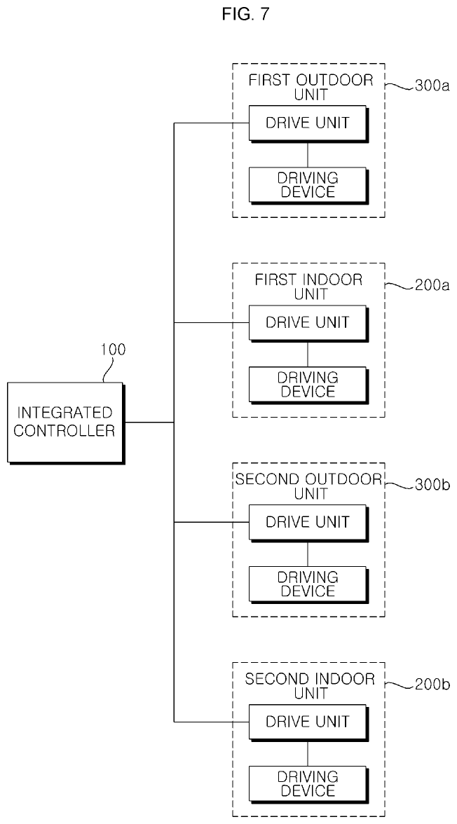

FIG. 7 is a view for explaining a method of controlling an indoor unit and an outdoor unit by an integrated controller in an air conditioner system of the present invention.

The indoor unit 200 and the outdoor unit 300 of the air conditioner system of the present invention may not include the main controller.

The integrated controller 100 may perform direct control for at least one of the indoor unit 200 and the outdoor unit 300 separately.

The integrated controller 100 may perform direct control for the indoor unit 200 and the outdoor unit 300 that do not include the main controller.

The direct control means that the integrated controller 100 directly controls the outdoor unit 300 or the indoor unit 200 without using the main controller of the outdoor unit 300 or the indoor unit 200.

The direct control is a control that is accomplished according to the control signal of the integrated controller 100, when the outdoor unit 300 or the indoor unit 200 does not have the main controller. In this case, the control signal provided by the integrated controller 100 may be named a direct control signal.

The integrated control unit 100 may transmit the direct control signal for directly controlling at least one driving device included in each of the outdoor unit 300 and the indoor unit 200, with respect to a direct control target among the outdoor unit 300 and the indoor unit 200.

The drive unit of each of the indoor unit 200 and the outdoor unit 300 may drive the driving device, in response to the direct control signal transmitted by the integrated controller 100. For example, the fan drive unit of the second outdoor unit 300 may drive the fan of the second outdoor unit 300 at a speed corresponding to the direct control signal of the integrated controller 100.

The integrated controller 100 may acquire state information for the indoor unit 200 and the outdoor unit 300 from the drive units of the indoor unit 200 and the outdoor unit 300. For example, the integrated controller 100 may receive information on the operating states of the indoor unit 200 and the outdoor unit 300 from the drive units of the indoor unit 200 and the outdoor unit 300.

Unlike FIG. 7, at least one of the indoor unit 200 and the outdoor unit 300 may include a main controller. For example, the first outdoor unit 300a, the second outdoor unit 300b, and the second indoor unit 200b do not include the main controller, and the first indoor unit 200a may include the main controller. In this case, the integrated controller 100 performs direct control for the first and second outdoor units 300a and 300b and the second indoor unit 200b, and performs indirect control for the first indoor unit 200a.

The integrated controller 100 may separately perform indirect control, with respect to the indoor unit 200 or the outdoor unit 300 that is not direct control target. The integrated controller 100 may perform indirect control, with respect to the indoor unit 200 or the outdoor unit 300 that includes the main controller.

The integrated controller 100 may transmit a direct control signal for directly controlling at least one driving device included in each of the outdoor unit 300 and the indoor unit 200, with respect to the indoor unit 200 or the outdoor unit 300 that is a direct control target.

For example, when the outdoor unit 300 does not include the main controller, the communication unit may receive the direct control signal. One or more drive units included in the outdoor unit 300 may drive a corresponding driving device, based on the indirect control signal.

For example, when the indoor unit 200 does not include the main controller, the communication unit may directly receive the direct control signal. One or more drive units included in the indoor unit 200 may drive a corresponding driving device, based on the indirect control signal.

The integrated controller 100 may transmit an indirect control signal for controlling the outdoor unit 300 and the indoor unit 200 by the main controller included in each of the outdoor unit 300 and the indoor unit 200, with respect to the indoor unit 200 or the outdoor unit 300 that is an indirect control target.

For example, when the outdoor unit 300 includes the main controller, the main controller may receive the indirect control signal through the communication unit. The main controller may control at least one driving device included in the outdoor unit 300, based on the indirect control signal.

For example, when the indoor unit 200 includes the main controller, the main controller may receive the indirect control signal through the communication unit. The main controller may control at least one driving device included in the indoor unit 200, based on the indirect control signal.

According to an embodiment of the present invention, both the outdoor unit 300 and the indoor unit 200 of the air conditioner system may not include the main controller. In this case, the integrated controller 100 may perform direct control by directly transmitting control signal separately to the outdoor unit 300 and the indoor unit 200.

According to another embodiment of the present invention, the outdoor unit 300 of the air conditioner system does not include the main controller, and the indoor unit 200 of the air conditioner system may include the main controller. In this case, the integrated controller 100 may perform direct control by transmitting direct control signal to the outdoor unit 300 separately. The integrated controller 100 may perform indirect control by transmitting an indirect control signal to the indoor unit 200 separately.

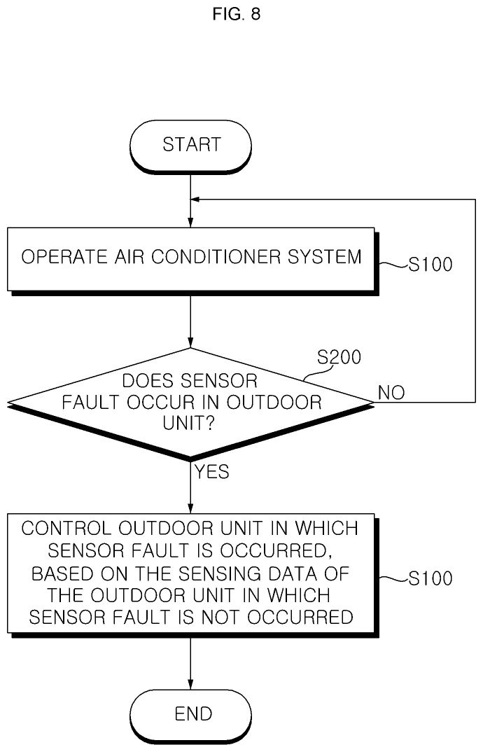

Hereinafter, referring to FIG. 8 to FIG. 10, a process in which the air conditioner system according to the present invention corresponds to sensor fault of the outdoor unit will be described in detail.

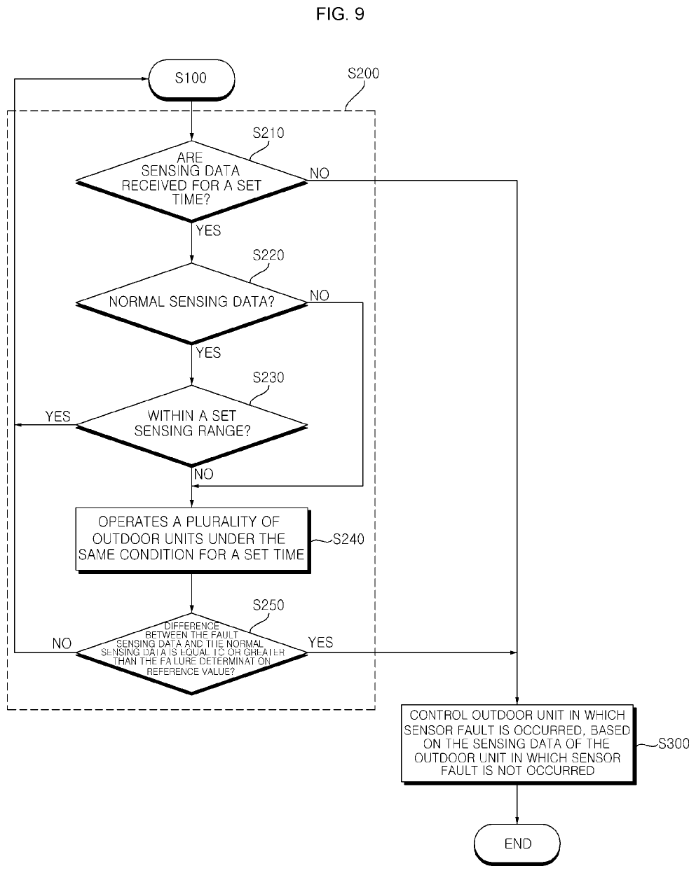

FIG. 8 and FIG. 9 are flowcharts for explaining a method of controlling an air conditioner system according to the present invention.

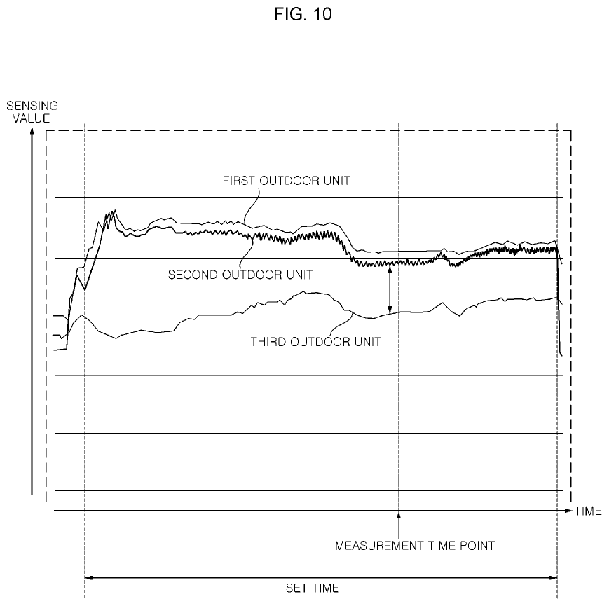

FIG. 10 is a view for explaining a state where an integrated controller of the present invention compares sensor data while operating a plurality of outdoor units under the same condition.

Referring to FIG. 8, among a plurality of outdoor units, when there is an outdoor unit that is determined to have a sensor fault, the integrated controller 100 may control the outdoor unit 100 having a sensor fault, based on the sensing data of the outdoor unit having no sensor fault. Each step of FIG. 8 will be described in detail below.

The integrated controller 100 may operate the air conditioner system, by separately controlling a plurality of indoor units and a plurality of outdoor units (S100).

The integrated controller 100 may control the operation of the plurality of indoor units and the plurality of outdoor units, by transmitting control signal to the plurality of indoor units and the plurality of outdoor units.

The plurality of indoor units and the plurality of outdoor units may transmit state information to the integrated controller 100.

The state information may represent how the indoor unit and the outdoor unit included in the air conditioner system operate respectively, and various data acquired during operation. For example, the state information may include data representing a cumulative record of a specific operation of each device, data representing operation setting of each device, and sensing data.

The sensing data may be a sensing value detected by various sensors provided in the outdoor unit or the indoor unit. For example, each of the outdoor unit and the outdoor unit may have at least one sensor for detecting a value for at least one of temperature, pressure, and humidity, and transmit the detected value through each sensor to the integrated controller 100. Accordingly, the integrated controller 100 may determine the temperature, pressure, and humidity of the inside or surrounding environment of the outdoor unit and the indoor unit. The integrated controller 100 may control the outdoor unit and the indoor unit, based on various sensing data transmitted by the outdoor unit and the indoor unit respectively.

The integrated controller 100 may determine whether sensor fault occurs in at least one of the plurality of outdoor units (S200).

The step of determining, by the integrated controller 100, whether sensor fault occurs in at least one of the plurality of outdoor units may be referred to as a determination step.

The integrated controller 100 may determine an outdoor unit that does not transmit sensing data for a set time, among the plurality of outdoor units, as an outdoor unit in which sensor fault occurs. When the outdoor unit is operated, various sensors provided in the outdoor unit may acquire sensor data in real time, and the outdoor unit transmits the sensor data acquired through the sensor to the integrated controller 100 at a certain cycle. Accordingly, the integrated controller 100 may periodically receive the sensing data of the outdoor unit. The set time may be a time longer than a reception period of the sensing data, or may be a value determined by experiments. If the sensing data can not be acquired as a fault occurs in the sensor of the outdoor unit, the integrated controller 100 can not receive sensing data for a set time or more.

The integrated controller 100 may separately determine whether sensor fault is occurred in each of the plurality of outdoor units, based on the sensing data of each of the plurality of outdoor units.

For example, the integrated controller 100 may determine that sensor fault is occurred in the outdoor unit that transmits abnormal sensing data. The integrated controller 100 may determine that abnormal sensing data is received, when the sensing data transmitted from the outdoor unit includes errors, can not be not interpreted on a program basis, or is not interpreted.

For example, the integrated controller 100 may determine that sensor fault is occurred in the outdoor unit that transmits the sensing data which deviates from a set sensing range. If a plurality of data are included in the sensing data, when data exceeding the set sensing range is included, it can be determined that sensor fault is occurred in a corresponding outdoor unit. The set sensing range may be a preset range for the value indicated by the sensing data. For example, the set sensing range for the sensing data of the temperature sensor disposed in the refrigerant pipe through which the refrigerant is discharged from the compressor may range from 10 to 100 degrees Celsius. In this case, when the value indicated by the sensing data of the temperature sensor disposed in the refrigerant pipe through which the refrigerant is discharged from the compressor is less than 10 degrees or exceeds 100 degrees, the integrated controller 100 may determine that sensor fault is occurred in a corresponding outdoor unit. The set sensing range may be different depending on the type and arrangement of the sensor. The set sensing range according to the type and arrangement of the sensor may be determined by experiment, and may be stored in the memory as data.

The integrated controller 100 may first determine sensor fault based on the sensing data itself transmitted by the outdoor unit, and then secondarily check sensor fault by comparing the sensing data with other outdoor unit. Accordingly, the air conditioner system of the present invention can more accurately determine sensor fault. This will be described in detail with reference to FIG. 9.

When there is an outdoor unit in which it is determined that sensor fault is occurred, among the plurality of outdoor units, the integrated controller 100 may control the outdoor unit in which sensor fault is occurred, based on the sensing data of the outdoor unit in which sensor fault is not occurred (S300).

When it is determined that sensor fault is occurred, the step of controlling, by the integrated controller 100, the outdoor unit where sensor fault is occurred, based on the sensing data of the outdoor unit in which sensor fault is not occurred, may be named as a control step.

Since the integrated controller 100 needs the sensing data of the outdoor unit so as to control the outdoor unit, the integrated controller 100 can not normally control the outdoor unit when a sensor fault is occurred in the outdoor unit. Accordingly, the outdoor unit in which sensor fault is occurred can not be operated.

However, when similar outdoor unit is operated in similar setting in similar environment, the sensing data acquired by the outdoor unit shall be similar to each other. Therefore, the integrated controller 100 may control the outdoor unit in which sensor fault is occurred, based on the sensing data transmitted by the outdoor unit in which sensor fault is not occurred. Accordingly, even the outdoor unit in which sensor fault is occurred may be continuously operated based on sensing data of other outdoor unit.

The integrated controller 100 may select the outdoor unit having the same capacity as that of the outdoor unit in which sensor fault is occurred or having the capacity difference that is equal to or less than a set amount, among the plurality of outdoor units, and control the outdoor unit in which sensor fault is occurred, based on the sensing data of the selected outdoor unit.

When there are a plurality of outdoor units in which sensor fault is not occurred, the integrated controller 100 may control the outdoor unit in which sensor fault is occurred, based on the sensing data of one of the outdoor units in which sensor fault is not occurred. The integrated controller 100 may arbitrarily select one outdoor unit among the outdoor units in which sensor fault is not occur, and control the outdoor unit in which sensor fault is occurred based on the sensing data of the selected outdoor unit.

The integrated controller 100 may control the outdoor unit in which sensor fault is occurred, based on the sensing data of the outdoor unit disposed in an environment similar to the outdoor unit in which sensor fault is occurred among the plurality of outdoor units. For example, the integrated controller 100 may control the outdoor unit in which sensor fault is occurred, based on the sensing data of the outdoor unit physically closest to the outdoor unit in which sensor fault is occurred, among a plurality of outdoor units in which sensor fault is not occurred.

When there are a plurality of outdoor units in which sensor fault is not occurred, the integrated controller 100 may control the outdoor unit in which sensor fault is occurred, based on the average value of the sensing data of the outdoor unit in which sensor fault is not occurred. Since the average value of the sensing data of the outdoor unit in which sensor fault is not occurred is used, the outdoor unit in which sensor fault is occurred can operate more stably.

When there are a plurality of outdoor units in which sensor fault is not occurred, the integrated controller 100 may select, among the outdoor units in which sensor fault is not occurred, the outdoor unit having the same compressor capacity as that of the outdoor unit in which sensor fault is occurred, and may control the outdoor unit in which sensor fault is occurred, based on the sensing data of the selected outdoor unit.

When there is no outdoor unit having the same compressor capacity as that of the outdoor unit in which sensor fault is occurred among the outdoor units in which sensor fault is not occurred, the integrated controller 100 may control the outdoor unit in which sensor fault is occurred, based on the sensing data of the outdoor unit having the closest compressor capacity. In this case, the integrated controller 100 may reflect the correction value based on a difference in the compressor capacity to the sensing data, and may control the outdoor unit in which sensor fault is occurred based on the sensing data to which the correction value is reflected.

Among the outdoor units in which sensor fault is not occurred, the integrated controller 100 may select the outdoor unit in which at least one of the number of compressors, the capacity, the number of fans, and the model type is most similar to the outdoor unit in which sensor fault is occurred. The integrated controller 100 may control the outdoor unit in which sensor fault is occurred based on the sensing data of the selected outdoor unit.

Referring to FIG. 9, the integrated controller 100 may determine sensor fault of the outdoor unit through two steps.

During the control of air conditioner system (S100), the integrated controller 100 may determine whether respective sensing data are received from a plurality of outdoor units for a set time (S210).

Accordingly, the integrated controller 100 may determine whether there is an outdoor unit that does not transmit sensing data for a set time, among a plurality of outdoor units.

The set time may be longer than the period when the integrated controller 100 receives the sensing data transmitted from the outdoor unit. If the set time is longer than the reception period of the sensing data, the outdoor unit normally transmitting the sensing data shall transmit the sensing data at least once, and the integrated controller 100 may receive the sensing data at least once. In this case, among the plurality of outdoor units, the integrated controller 100 may determine that a sensor fault is occurred in the outdoor unit that does not transmit the sensing data within a set time.

The integrated controller 100 may determine that the outdoor unit that does not transmitted the sensing data during the set time is in sensor fault state, and may control based on the sensing data of the outdoor unit in which sensor fault is not occurred (S300). When the sensing data is not received, it is not necessary to determine whether the sensing data is normal sensing data or data within the set sensing range, so that the integrated controller 100 may enter a control step.

If it is determined that all of the plurality of outdoor units transmit the sensing data during the set time, the integrated controller 100 may determine whether the sensing data received from the plurality of outdoor units is normal data (S220).

Accordingly, when there is no outdoor unit that does not transmit the sensing data during the set time, the integrated controller 100 may determine whether there exists an outdoor unit that transmits abnormal sensing data.

The integrated controller 100 may determine that the outdoor unit transmitted the abnormal sensing data is an outdoor unit in which the sensor fault is occurred.

The abnormal sensing data may be sensing data composed of the code or machine language that is out of the preset format for the sensing data. If the received data is not interpreted as sensing data, the integrated controller 100 may determine that the received data is abnormal sensing data.

If it is determined that there is no abnormal sensing data, the integrated controller 100 may determine whether the sensing data received from the plurality of outdoor units is within the set sensing range (S230).

The integrated controller 100 may determine whether there exists sensing data that deviates from the set sensing range, among the normal sensing data.

The set sensing range is a preset range with respect to a normal value measured by a corresponding sensor according to the type of the sensor and the arrangement in the outdoor unit. For example, the set sensing range for a temperature sensor disposed in the expansion valve may range from 30 to 80 degrees Celsius. The integrated controller 100 may determine whether any sensing data of the respective expansion valve temperature sensors transmitted by the plurality of outdoor units deviates from the set sensing range.

The integrated controller 100 may determine the outdoor unit that transmitted the sensing data that deviates from the set sensing range to be the outdoor unit in which sensor fault has occurred.

Steps S210 to S230 may be referred to as a first determination step for determining sensor fault of the outdoor unit. In the air conditioner system of the present invention, a more accurate determination can be achieved because the first determination step and a second determination step are performed in determining sensor fault of the outdoor unit. When it is determined that sensor fault is occurred in the outdoor unit in the first determination step, the integrated controller 100 may determine sensor fault once again through the second determination step. Hereinafter, the second determination step will be described.

When there is an outdoor unit that transmits abnormal sensing data or sensing data that deviates from the set sensing range among the plurality of outdoor units, the integrated controller 100 may operate the plurality of outdoor units for a set time under the same condition (S240). The set time may be data stored in memory, and may be set by user.

The integrated controller 100 may accumulate and store received sensing data while operating a plurality of outdoor units under the same condition for a set time. The set time is a time for operating a plurality of outdoor units for the second determination and a time that can be set by a user. The same conditions mean that the operation setting of a plurality of outdoor units are the same.

For example, when there is an outdoor unit in which sensor fault is occurred in the first determination step, the integrated controller 100 may control the drive units of a plurality of outdoor units to be driven with the same setting for 5 minutes. Thus, each of the fans included in the plurality of outdoor units is rotated at the same speed, and each of the valves is controlled at the same speed and at the same rotation angle, and each compressor may perform the same operation.

The integrated controller 100 may compare the first sensing data of the outdoor unit in which sensor fault is occurred and the second sensing data of the remaining outdoor units while operating the plurality of outdoor units under the same condition for a set time.

The first sensing data is sensing data transmitted to the outdoor unit determined as a sensor fault in the first determination step. The second sensing data may be sensing data excluding the first sensing data. Alternatively, when a plurality of outdoor units have various capacities and are installed in various environments, the second sensing data may be sensing data transmitted by the outdoor unit having the same capacity as the outdoor unit that transmits the first sensing data and installed in the same environment.

The integrated controller 100 may determine whether the difference between the first sensing data of the outdoor unit in which sensor fault is occurred and the second sensing data of the remaining outdoor units is equal to or greater than a failure determination reference value (S250).

The failure determination reference value may be a reference value for checking whether the outdoor unit transmitting the first sensing data is failed. The failure determination reference value may be a value set for the difference between the first sensing data and the second sensing data. The failure determination reference value may be a value determined by an experiment, and may be a value stored in the memory.

For example, when there are a plurality of remaining outdoor units, the integrated controller 100 may compare the average value of the second sensing data with the first sensing data.

For example, when there are a plurality of remaining outdoor units, the integrated controller 100 may compare the second sensing data transmitted by an arbitrary outdoor unit among the remaining outdoor units with the first sensing data.

Referring to FIG. 10, a graph of the first sensing data and the second sensing data received by the integrated controller 100 for a set time under the same condition of a plurality of outdoor units are shown.

The third outdoor unit is an outdoor unit determined to have a sensor fault in the first determination step, and the first and second outdoor units are outdoor units determined not to have a sensor fault. There exists a difference between the first sensing data transmitted by a third outdoor unit and the second sensing data transmitted by the first outdoor unit and the second outdoor unit.

The integrated controller 100 may compare one of the average value of the second sensing data and the second sensing data with the first sensing data at a specific measurement time of the set time.

If the difference between the average value of the second sensing data and the first sensing data is greater than or equal to the failure determination reference value at the time of measurement, the integrated controller 100 may finally determine that sensor fault is occurred in the third outdoor unit.

If the difference between the first sensing data and the second sensing data is greater than or equal to the failure determination reference value, the integrated controller 100 may finally determine that sensor fault is occurred in the outdoor unit that transmitted abnormal sensing data or sensing data that deviates from the set sensing range.

If the difference between the first sensing data and the second sensing data is less than the failure determination reference value, the integrated controller 100 may finally determine that sensor fault is not occurred in the outdoor unit that transmitted the abnormal sensing data or the sensing data that deviates from the set sensing range.

If the difference between the first sensing data and the second sensing data is greater than or equal to the failure determination reference value, the integrated controller 100 may control the outdoor unit that transmits the first sensing data, based on the sensing data of the outdoor unit that transmits the second sensing data.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1. An air conditioner system comprising:
a plurality of indoor units;
a plurality of outdoor units; and
an integrated controller for separately controlling the plurality of indoor units and the plurality of outdoor units,
wherein, when it is determined that a sensor fault is occurred in a first outdoor unit among the plurality of outdoor units, the integrated controller controls the first outdoor unit, based on sensing data of remaining outdoor units in which sensor fault is not occurred excluding the first outdoor unit.

2. The air conditioner system of claim 1, wherein, when the first sensing data received from the first outdoor unit is abnormal sensing data, or when the first sensing data received from the first outdoor unit deviates from a set sensing range, the integrated controller determines that the first outdoor unit is an outdoor unit in which sensor fault is occurred.

3. The air conditioner system of claim 1, wherein the integrated controller compares a first sensing data of the first outdoor unit with a second sensing data of remaining outdoor unit while operating the plurality of outdoor units under the same condition for a set time,
determines that sensor fault is occurred in the first outdoor unit when a difference between the first sensing data and the second sensing data is greater than or equal to a preset failure determination reference value, and
determines that sensor fault is not occurred in the first outdoor unit when the difference between the first sensing data and the second sensing data is less than the failure determination reference value.

4. The air conditioner system of claim 3, wherein the integrated controller compares an average value of the second sensing data with the first sensing data, when there are a plurality of remaining outdoor units.

5. The air conditioner system of claim 1, wherein the integrated controller determines that sensor fault is occurred in the first outdoor unit when sensing data is not transmitted from the first outdoor unit for a preset time, among the plurality of outdoor units.

6. The air conditioner system of claim 1, wherein, when there are a plurality of the remaining outdoor units in which sensor fault is not occurred, the integrated controller controls the first outdoor unit, based on an average value of sensing data of the remaining outdoor units.

7. The air conditioner system of claim 1, wherein, when there are a plurality of the remaining outdoor units in which sensor fault is not occurred, the integrated controller controls the first outdoor unit, based on any one sensing data, among the remaining outdoor units.

8. The air conditioner system of claim 7, wherein the integrated controller controls the first outdoor unit, based on sensing data of an outdoor unit located physically closest to the first outdoor unit, among the remaining outdoor units.

9. A method of controlling an air conditioner system comprising a plurality of indoor units, a plurality of outdoor units, and an integrated controller for separately controlling the plurality of indoor units and the plurality of outdoor units, the method comprising:
a reception step of receiving sensing data from the plurality of outdoor units by the integrated controller;
a determination step of determining that sensor fault is occurred in the first outdoor unit, among the plurality of outdoor units corresponding to the sensing data, by the integrated controller; and
a control step of controlling the first outdoor unit, based on sensing data of remaining outdoor units in which sensor fault is not occurred excluding the first outdoor unit.

10. The method of claim 9, wherein the determination step comprises determining that sensor fault is occurred in the first outdoor unit, when sensing data is not received from the first outdoor unit for a preset time among the plurality of outdoor units.

11. The method of claim 9, wherein the determination step comprises determining that the first outdoor unit is an outdoor unit in which sensor fault is occurred, when a first sensing data received from the first outdoor unit is abnormal sensing data.

12. The method of claim 11, wherein the determination step comprises determining that abnormal sensing data is received, when the first sensing data includes an error, or when the first sensing data is not interpreted.

13. The method of claim 9, wherein the determination step comprises determining that the first outdoor unit is an outdoor unit in which sensor fault is occurred, when a first sensing data received from the first outdoor unit deviates from a set sensing range.

14. The method of claim 9, wherein the determination step further comprises the steps of:
operating the plurality of outdoor units for a set time under the same condition;
determining whether a difference between a first sensing data of the first outdoor unit and a second sensing data of the remaining outdoor unit is greater than or equal to a failure determination reference value; and
finally determining that a sensing error has occurred in the first outdoor unit if the difference between the first sensing data and the second sensing data is greater than or equal to the failure determination reference value.

15. The method of claim 14, further comprising a step of determining that sensor fault is not occurred in the first outdoor unit, when the difference between the first sensing data and the second sensing data is less than the failure determination reference value.
